(19) United States
(12) Patent Application Publication
(10) Pub. No.: US 2018/0096663 A1
(43) Pub. Date: Apr. 5, 2018

(54) PIXEL DRIVING CIRCUIT

(71) Applicant: Shenzhen China Star Optoelectronics Technology Co., Ltd., Shenzhen City (CN)

(72) Inventor: Xiangyang Xu, Shenzhen City (CN)

(21) Appl. No.: 15/109,131

(22) PCT Filed: May 17, 2016
(86) PCT No.: PCT/CN2016/082412

§ 371 Date: Jun. 30, 2016

(30) Foreign Application Priority Data
Jan. 28, 2016 (CN) 201610061785.2

(51) Int. Cl. G09G 3/36; G02F 1/1343; G02F 1/1362

(52) U.S. Cl. CPC G09G 3/3648; G09G 3/3607; G02F 1/136286; G02F 1/134336; G02F 1/13624; G09G 3/3677

(57) ABSTRACT

The present invention provides a pixel driving circuit. The nth main gate scan lines and the nth charge share gate scan lines are located corresponding to the pixel units of the nth row. The main gate scan line controls the charge of the main region pixel electrode and the sub region pixel electrode, and the charge share gate scan line controls the voltage level of the sub region pixel electrode to be pulled down. The first GOA driving module and the second GOA driving module are respectively located to provide the main gate scan pulse signal and the charge share gate scan pulse signal, and the first GOA driving module performs driving with advancing one pulse width before the second GOA driving module so that the nth main gate scan pulse signal advances one pulse width before the nth charge share gate scan pulse signal.

### FIELD OF THE INVENTION

The present invention relates to a display technology field, and more particularly to a pixel driving circuit.

### BACKGROUND OF THE INVENTION

The Liquid Crystal Display (LCD) is one of the most widely utilized flat panel displays, and the liquid crystal display panel is the core component of the Liquid Crystal Display. The liquid crystal display panel generally comprises a Thin Film Transistor Array Substrate (TFT Array Substrate), a Color Filter (CF) and a Liquid Crystal Layer arranged between the two substrates. Generally, the pixel electrode and the common electrode are respectively arranged on the array substrate and the color filter substrate. As the voltages are applied to the pixel electrodes and the common electrodes, the electrical field can be generated in the liquid crystal layer, and the electrical field determines the orientation of the liquid crystal molecules, and then to adjust the polarization of the light incident into the liquid crystal layer for making the liquid crystal display panel show images.

The technology of Polymer Stabilized Vertical Alignment (PSVA) is developed in the present industry, and correspondingly, the PSVA type liquid crystal panel. The PSVA technology is to add the Monomer with proper concentration into the liquid crystal material and uniformly to vibrate the same; then, the liquid crystal material after mixing is located on the heater to be heated to be in the Isotropy state. When the temperature drops to the room temperature, the liquid crystal mixture is recovered back to the Nematic state; then, the liquid crystal mixture is injected between the array substrate and the color filter substrate and the voltages are applied thereto; as applying the voltages to make the alignment of the liquid crystal molecules stable, the ultraviolet light or heating is employed to make the polyreaction take place to the Monomer to form the polymer layer, and thereby, to achieve the objective of stably align the liquid crystal molecules.

As shown in FIG. 1, for enlarging the view angle, the pixel electrode is generally designed to be a pozidriv structure in prior art. The pixel electrode comprises the strip vertical trunk 100 and strip horizontal trunk 200, and the centers of the vertical trunk 100 and the horizontal trunk 200 are perpendicularly intersecting. The center intersection means that the vertical trunk 100 and the horizontal trunk 200 are orthogonal, and the two equally split the area of the entire pixel electrode into 4 domains. Each pixel electrode region is composed with spread strip branches (Slit) 300 appearing ±45°, ±135° angles with the vertical trunk 100 or the horizontal trunk 200. The respective strip branches 300 are positioned in the same plane where the vertical trunk 100 and the horizontal trunk 200 are to form the pozidriv pixel electrode structures which are mirror symmetric up and down, left and right shown in FIG. 1.

In such kind of the pozidriv pixel electrode structure, the strip branch 300 in each pixel electrode region has the same included angle with the vertical trunk 100 and the horizontal trunk 200, and therefore, a certain visual color difference or visual color deviation must exist, and the transmittance of the liquid crystal panel will drop.

For improving the visual color difference or visual color deviation, the prior art is to divide one sub pixel into a main region and a sub region. One independent main region pixel electrode is positioned in the main region, and one independent sub region pixel electrode is positioned in the sub region. Both the main region pixel electrode and the sub region pixel electrode utilize the pozidriv structure design shown in the aforesaid FIG. 1. As shown in FIG. 2, the pixel driving circuit on the TFT array substrate according to prior art comprises a plurality of pixel units 500 aligned in array, nth main gate scan lines G(n), being located from top to bottom corresponding to pixel units of nth rows and extending along a horizontal direction and mth data lines D(m), being located from left to right corresponding to the pixel units of mth columns and extending along a vertical direction, and both n and m are positive integers. Each pixel unit comprises a first thin film transistor T10, a second thin film transistor T20, a third thin film transistor T30, a main region pixel electrode 501, a sub region pixel electrode 502 and a charge share capacitor C10. For the pixel unit 500 of the nth row, the mth column, a gate of the first thin film transistor T10 is electrically coupled to the nth main gate scan line G(n), and a source is electrically coupled to the mth data line D(m), and the drain is electrically coupled to the main region pixel electrode 501, and a gate of the second thin film transistor T20 is electrically coupled to the nth main gate scan line G(n), and a source is electrically coupled to the mth data line D(m), and the drain is electrically coupled to the sub region pixel electrode 502, and a gate of the third thin film transistor T30 is electrically coupled to the n+1th gate scan line G(n+1) corresponded with the pixel units of the next row, and a source is electrically coupled to the sub region pixel electrode 502, and a drain is electrically coupled to one end of the charge share capacitor C10, and the other end of the charge share capacitor C10 receives a common voltage Com.

The pixel driving circuit shown in FIG. 2 is only applied for the single direction scan. Namely, the gate scan pulse signal is provided from the first row to the last row line by line. As scanning the pixel units 500 of the nth row, the nth gate scan pulse signal is a high voltage level pulse, and the nth gate scan line G(n) transmits a high voltage level signal, and all the first thin film transistors T10 and the second thin film transistors T20 in the pixel units 500 of the nth row are first activated, and the third thin film transistors T3 are deactivated, and the main region pixel electrode 501 and the sub region pixel electrode 502 in the pixel unit 500 of the nth row, the mth column are charged to the same voltage level; then, as scanning the pixel units 500 of the n+1th row, the n+1th gate scan pulse signal is a high voltage level pulse, and the n+1th gate scan line G(n+1) transmits a high voltage level signal, and all the first thin film transistors T1 and the second thin film transistors T2 in the pixel units 500 of the nth row are deactivated, and the third thin film transistors T30 are activated, and the charge share capacitor C10 in the pixel unit 500 of the nth row, the mth column pulls down the voltage level of the sub region pixel electrode 502 so that the voltages of the main region pixel electrode 501 and the sub region pixel electrode 502, and thus to eliminate the color washout phenomenon of the liquid crystal panel due to the different angles.

While in the backward scan, i.e. the gate scan pulse signal is provided from the last row to the first row line by line, the voltages of the main region pixel electrode 501 and the sub region pixel electrode 502 in the pixel unit 500 of the nth row, the mth column are kept to be the same after charging, and the color washout phenomenon cannot be realized.

### SUMMARY OF THE INVENTION

An objective of the present invention is to provide a pixel driving circuit, which can realize the function of color shift compensation to promote the display quality of the liquid crystal panel.

For realizing the aforesaid objective, the present invention provides a pixel driving circuit, comprising: a plurality of pixel units aligned in array, nth main gate scan lines, being located from top to bottom corresponding to pixel units of nth rows and extending along a horizontal direction, nth charge share gate scan lines, being located from top to bottom corresponding to pixel units of the nth rows and extending along the horizontal direction and mth data lines, being located from left to right corresponding to the pixel units of mth columns and extending along a vertical direction, and both n and m are positive integers;

each pixel unit comprises a first thin film transistor, a second thin film transistor, a third thin film transistor, a main region pixel electrode, a sub region pixel electrode and a charge share capacitor; for the pixel unit of the nth row, the mth column, a gate of the first thin film transistor is electrically coupled to the nth main gate scan line, and a source is electrically coupled to the mth data line, and the drain is electrically coupled to the main region pixel electrode, and a gate of the second thin film transistor is electrically coupled to the nth main gate scan line, and a source is electrically coupled to the mth data line, and the drain is electrically coupled to the sub region pixel electrode, and a gate of the third thin film transistor is electrically coupled to the nth charge share gate scan line, and a source is electrically coupled to the sub region pixel electrode, and a drain is electrically coupled to one end of the charge share capacitor, and the other end of the charge share capacitor receives a common voltage;

the nth main gate scan line transmits a nth main gate scan pulse signal, the nth charge share gate scan line transmits a nth charge share gate scan pulse signal, and the nth main gate scan pulse signal advances one pulse width before the nth charge share gate scan pulse signal.

the pixel driving circuit further comprises: a first GOA driving module and a second GOA driving module, and the first GOA driving module is electrically coupled to all the main gate scan lines to provide the main gate scan pulse signal to the main gate scan lines, and the second GOA driving module is electrically coupled to all the charge share gate scan lines to provide the charge share gate scan pulse signal to the charge share gate scan lines;

the first GOA driving module and the second GOA driving module perform forward scan driving at the same time or perform the backward scan driving at the same time; the first GOA driving module performs driving with advancing one pulse width before the second GOA driving module.

A line by line scan of the main gate scan lines is started by inputting a first scan start signal to the first GOA driving module; a line by line scan of the charge share gate scan lines is started by inputting a second scan start signal to the second GOA driving module; the first scan start signal advances one pulse width before the second scan start signal.

As the first GOA driving module and the second GOA driving module perform forward scan driving at the same time, the first GOA driving module provides the main gate scan pulse signal in a sequence from the first to the last, and the main gate scan lines transmit the main gate scan pulse signal line by line from top to bottom in a sequence from the first to the last, and the second GOA driving module provides the charge share gate scan pulse signal in a sequence from the first to the last, and the charge share gate scan lines transmit the charge share gate scan pulse signal line by line from top to bottom in a sequence from the first to the last.

As the first GOA driving module and the second GOA driving module perform the backward scan driving at the same time, the first GOA driving module provides the main gate scan pulse signal in a sequence from the last to the first, and the main gate scan lines transmit the main gate scan pulse signal line by line from bottom to top in a sequence from the last to the first, and the second GOA driving module provides the charge share gate scan pulse signal in a sequence from the last to the first, and the charge share gate scan lines transmit the charge share gate scan pulse signal line by line from bottom to top in a sequence from the last to the first.

Both the main region pixel electrode and the sub region pixel electrode are pozidriv structures, and both materials are ITO.

Pulse widths of the main gate scan pulse signal and the charge share gate scan pulse signal are equal.

The first GOA driving module and the second GOA driving circuit are respectively located at left, right two sides of the plurality of pixel units aligned in array.

The present invention further provides a pixel driving circuit, comprising: a plurality of pixel units aligned in array, nth main gate scan lines, being located from top to bottom corresponding to pixel units of nth rows and extending along a horizontal direction, nth charge share gate scan lines, being located from top to bottom corresponding to pixel units of the nth rows and extending along the horizontal direction and mth data lines, being located from left to right corresponding to the pixel units of mth columns and extending along a vertical direction, and both n and m are positive integers;

each pixel unit comprises a first thin film transistor, a second thin film transistor, a third thin film transistor, a main region pixel electrode, a sub region pixel electrode and a charge share capacitor; for the pixel unit of the nth row, the mth column, a gate of the first thin film transistor is electrically coupled to the nth main gate scan line, and a source is electrically coupled to the mth data line, and the drain is electrically coupled to the main region pixel electrode, and a gate of the second thin film transistor is electrically coupled to the nth main gate scan line, and a source is electrically coupled to the mth data line, and the drain is electrically coupled to the sub region pixel electrode, and a gate of the third thin film transistor is electrically coupled to the nth charge share gate scan line, and a source is electrically coupled to the sub region pixel electrode, and a drain is electrically coupled to one end of the charge share capacitor, and the other end of the charge share capacitor receives a common voltage;

the nth main gate scan line transmits a nth main gate scan pulse signal, the nth charge share gate scan line transmits a nth charge share gate scan pulse signal, and the nth main gate scan pulse signal advances one pulse width before the nth charge share gate scan pulse signal;

the pixel driving circuit further comprises: a first GOA driving module and a second GOA driving module, and the first GOA driving module is electrically coupled to all the main gate scan lines to provide the main gate scan pulse signal to the main gate scan lines, and the second GOA driving module is electrically coupled to all the charge share gate scan lines to provide the charge share gate scan pulse signal to the charge share gate scan lines;

the first GOA driving module and the second GOA driving module perform forward scan driving at the same time or perform the backward scan driving at the same time; the first GOA driving module performs driving with advancing one pulse width before the second GOA driving module;

wherein both the main region pixel electrode and the sub region pixel electrode are pozidriv structures, and both materials are ITO.

The benefits of the present invention are: the present invention provides a pixel driving circuit of the present invention. The nth main gate scan lines and the nth charge share gate scan lines are located corresponding to the pixel units of the nth row. The main gate scan line controls the charge of the main region pixel electrode and the sub region pixel electrode, and the charge share gate scan line controls the voltage level of the sub region pixel electrode to be pulled down. The first GOA driving module is located to provide the main gate scan pulse signal, and the second GOA driving module is located to provide the charge share gate scan pulse signal, and the first GOA driving module performs driving with advancing one pulse width before the second GOA driving module so that the nth main gate scan pulse signal transmitted by the nth main gate scan line advances one pulse width before the nth charge share gate scan pulse signal transmitted by the nth charge share gate scan line. Either in the forward scan driving or the backward scan driving, the function of color shift compensation can be realized to promote the display quality of the liquid crystal panel.

### BRIEF DESCRIPTION OF THE DRAWINGS

In order to better understand the characteristics and technical aspect of the invention, please refer to the following detailed description of the present invention is concerned with the diagrams, however, provide reference to the accompanying drawings and description only and is not intended to be limiting of the invention.

In drawings,

FIG. 1 is a structure diagram of a pozidriv pixel electrode.

FIG. 2 is a circuit diagram of a pixel driving circuit according to prior art;

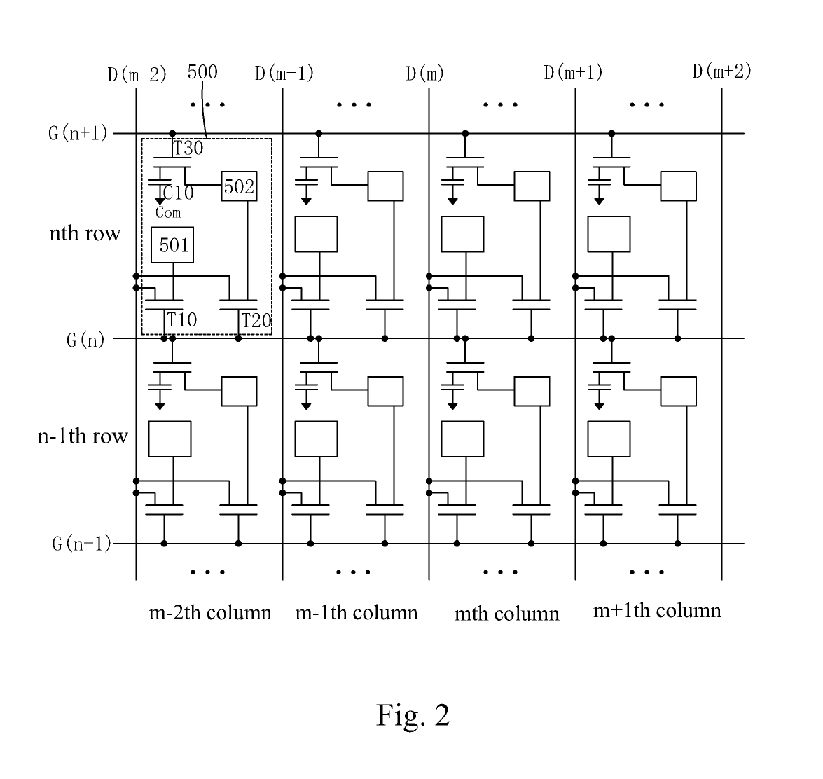

FIG. 3 is a circuit diagram of a pixel driving circuit according to the present invention;

FIG. 4 is a sequence diagram as the pixel driving circuit according to the present invention performs forward scan driving;

FIG. 5 is a sequence diagram as the pixel driving circuit according to the present invention performs backward scan driving.

### DETAILED DESCRIPTION OF PREFERRED EMBODIMENTS

For better explaining the technical solution and the effect of the present invention, the present invention will be further described in detail with the accompanying drawings and the specific embodiments.

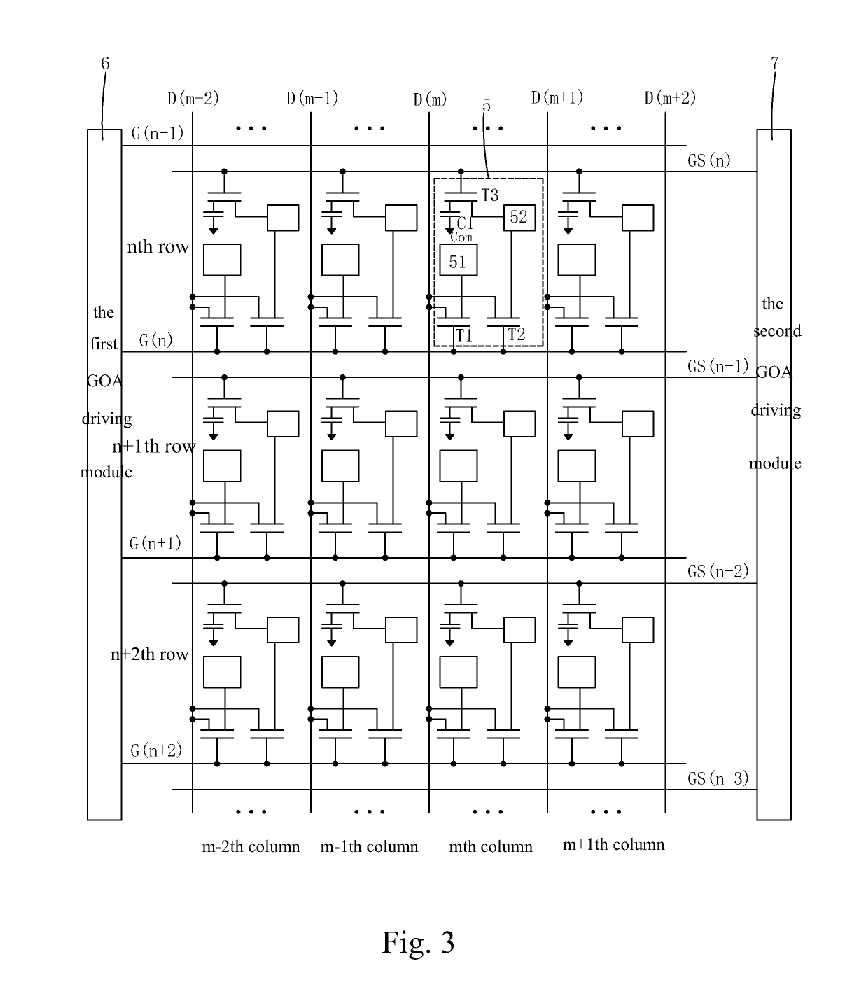

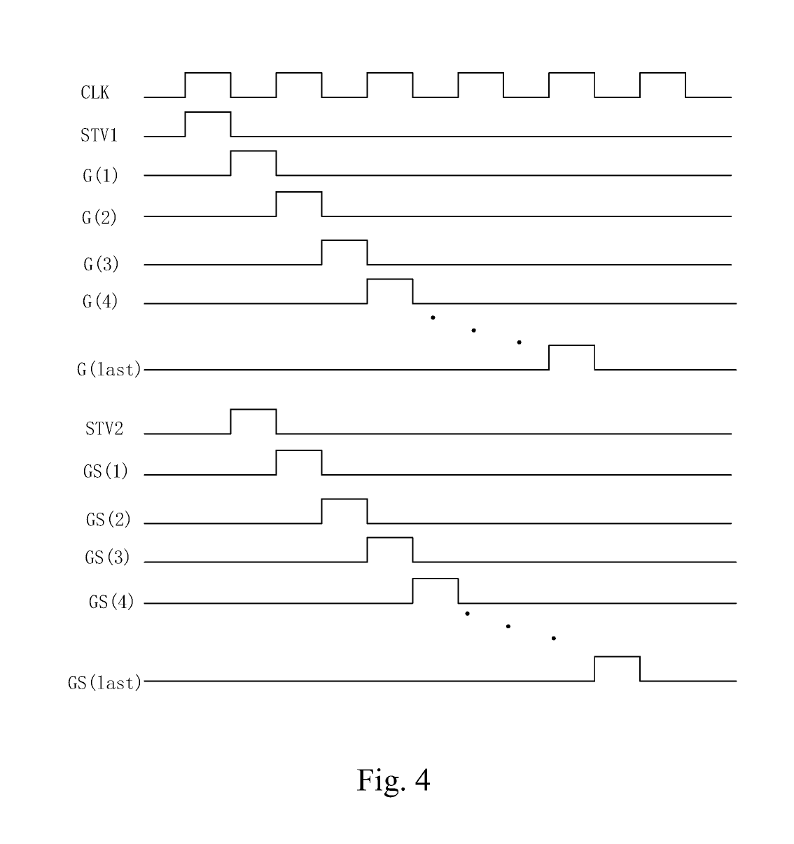

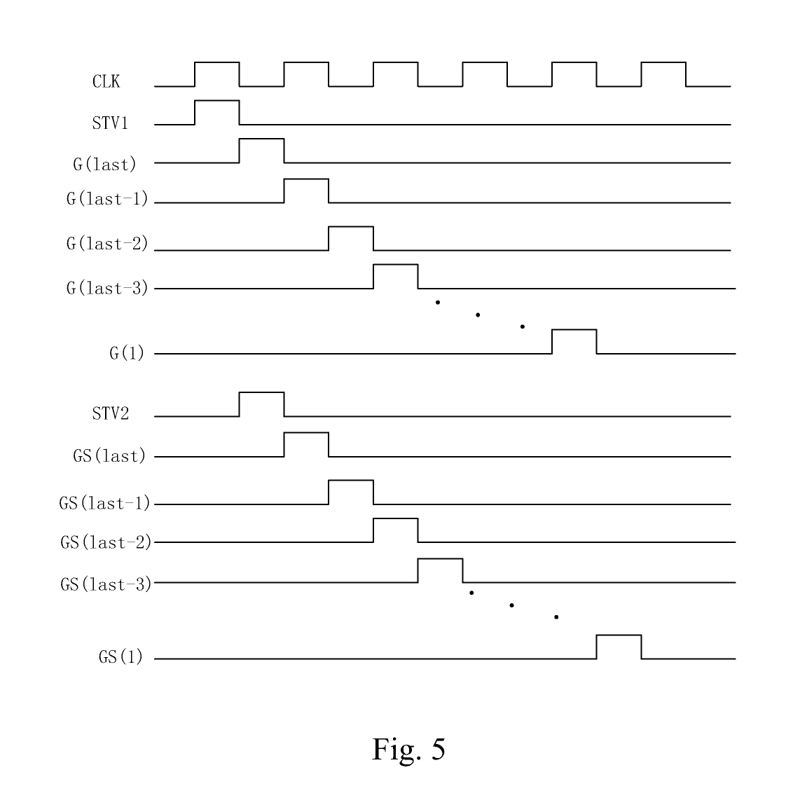

Please refer to FIG. 3, FIG. 4 and FIG. 5, the pixel driving circuit comprises: a plurality of pixel units 5 aligned in array, nth main gate scan lines G(n), being located from top to bottom corresponding to pixel units 5 of nth rows and extending along a horizontal direction, nth charge share gate scan lines GS(n), being located from top to bottom corresponding to pixel units 5 of the nth rows and extending along the horizontal direction and mth data lines D(m), being located from left to right corresponding to the pixel units 5 of mth columns and extending along a vertical direction, and both n and m are positive integers.

As shown in FIG. 3, each pixel unit 5 comprises: a first thin film transistor T1, a second thin film transistor T2, a third thin film transistor T3, a main region pixel electrode 51, a sub region pixel electrode 52 and a charge share capacitor C1. For the pixel unit 5 of the nth row, the mth column, a gate of the first thin film transistor T1 is electrically coupled to the nth main gate scan line G(n), and a source is electrically coupled to the mth data line D(m), and the drain is electrically coupled to the main region pixel electrode 51, and a gate of the second thin film transistor T2 is electrically coupled to the nth main gate scan line G(n), and a source is electrically coupled to the mth data line D(m), and the drain is electrically coupled to the sub region pixel electrode 52, and a gate of the third thin film transistor T3 is electrically coupled to the nth charge share gate scan line GS(n), and a source is electrically coupled to the sub region pixel electrode 52, and a drain is electrically coupled to one end of the charge share capacitor C1, and the other end of the charge share capacitor C1 receives a common voltage Com.

As shown in FIG. 4, FIG. 5, the nth main gate scan line G(n) transmits a nth main gate scan pulse signal, the nth charge share gate scan line GS(n) transmits a nth charge share gate scan pulse signal, wherein the main gate scan line controls the charge of the main region pixel electrode 51 and the sub region pixel electrode 52, and the charge share gate scan line controls the voltage level of the sub region pixel electrode 52 to be pulled down. Either in the forward scan driving or the backward scan driving, the nth main gate scan pulse signal advances one pulse width before the nth charge share gate scan pulse signal. Namely, for the pixel units 5 of the nth row either in the forward scan driving or the backward scan driving, the nth main gate scan pulse signal corresponded with the pixel units 5 of the nth row is always generated with one pulse width before the nth charge share scan pulse signal, and thus, all the first thin film transistors T1 and the second thin film transistors T2 in the pixel units 5 of the nth row are first activated, and the main region pixel electrode 51 and the sub region pixel electrode 52 in the pixel unit 5 of the nth row, the mth column are charged to the same voltage level, and after the charge is kept with one pulse width, all the first thin film transistors T1 and the second thin film transistors T2 in the pixel units 5 of the nth row are deactivated, and the third thin film transistors T3 are activated, and the charge share capacitor C1 in the pixel unit 5 of the nth row, the mth column pulls down the voltage level of the sub region pixel electrode 52 so that the voltage of the sub region pixel electrode 52 is smaller than the voltage level of the main region pixel electrode 51, the compensation generates the color shift because the view angles are different.

Furthermore, the pixel driving circuit further comprises: a first GOA driving module 6 and a second GOA driving module 7, and the first GOA driving module 6 is electrically coupled to all the main gate scan lines to provide the main gate scan pulse signal to the main gate scan lines, and the second GOA driving module 7 is electrically coupled to all the charge share gate scan lines to provide the charge share gate scan pulse signal to the charge share gate scan lines. The first GOA driving module 6 and the second GOA driving module 7 perform forward scan driving at the same time or perform the backward scan driving at the same time. The first GOA driving module 6 performs driving with advancing one pulse width before the second GOA driving module 7. Thus, the nth main gate scan pulse signal transmitted by the nth main gate scan line G(n) advances one pulse width before the nth charge share gate scan pulse signal transmitted by the nth charge share gate scan line GS(n). Preferably, the first GOA driving module 6 and the second GOA driving circuit 7 are respectively located at left, right two sides of the plurality of pixel units 5 aligned in array.

A line by line scan of the main gate scan lines is started by inputting a first scan start signal STV1 to the first GOA driving module 6; a line by line scan of the charge share gate scan lines is started by inputting a second scan start signal STV2 to the second GOA driving module 7; the first scan start signal STV1 advances one pulse width before the second scan start signal STV2.

Specifically, referring to FIG. 3 and FIG. 4 at the same time, as the first GOA driving module 6 and the second GOA driving module 7 perform forward scan driving at the same time, the first GOA driving module 6 provides the main gate scan pulse signal in a sequence from the first to the last, and the main gate scan lines transmit the main gate scan pulse signal line by line from top to bottom in a sequence from the first to the last, i.e. the sequence of G(1), G(2), G(3), G(4) until the last G(Last), and the second GOA driving module 7 provides the charge share gate scan pulse signal in a sequence from the first to the last, and the charge share gate scan lines transmit the charge share gate scan pulse signal line by line from top to bottom in a sequence from the first to the last, i.e. the sequence of GS(1), GS(2), GS(3), GS(4) until the last GS(Last). Meanwhile, the nth main gate scan pulse signal transmitted by the nth main gate scan line G(n) always advances one pulse width before the nth charge share gate scan pulse signal transmitted by the nth charge share gate scan line GS(n) to ensure that the corresponding pixel units 5 of the nth row first activate the first thin film transistors T1 and the second thin film transistors T2, and the main region pixel electrode 51 and the sub region pixel electrode 52 are charged to the same voltage level, and the third thin film transistors T3 are activated, and the charge share capacitor C1 pulls down the voltage level of the sub region pixel electrode 52.

Specifically, referring to FIG. 3 and FIG. 5 at the same time, as the first GOA driving module 6 and the second GOA driving module 7 perform the backward scan driving at the same time, the first GOA driving module 6 provides the main gate scan pulse signal in a sequence from the last to the first, and the main gate scan lines transmit the main gate scan pulse signal line by line from bottom to top in a sequence from the last to the first, i.e. the sequence of G(Last), G(Last−1), G(Last−2), G(Last−3) until the first G(1), and the second GOA driving module 7 provides the charge share gate scan pulse signal in a sequence from the last to the first, and the charge share gate scan lines transmit the charge share gate scan pulse signal line by line from bottom to top in a sequence from the last to the first, i.e. the sequence of GS(Last), GS(Last−1), GS(Last−2), GS(Last−3) until the first GS(1). Meanwhile, the nth main gate scan pulse signal transmitted by the nth main gate scan line G(n) always advances one pulse width before the nth charge share gate scan pulse signal transmitted by the nth charge share gate scan line GS(n) to ensure that the corresponding pixel units 5 of the nth row first activate the first thin film transistors T1 and the second thin film transistors T2, and the main region pixel electrode 51 and the sub region pixel electrode 52 are charged to the same voltage level, and the third thin film transistors T3 are activated, and the charge share capacitor C1 pulls down the voltage level of the sub region pixel electrode 52.

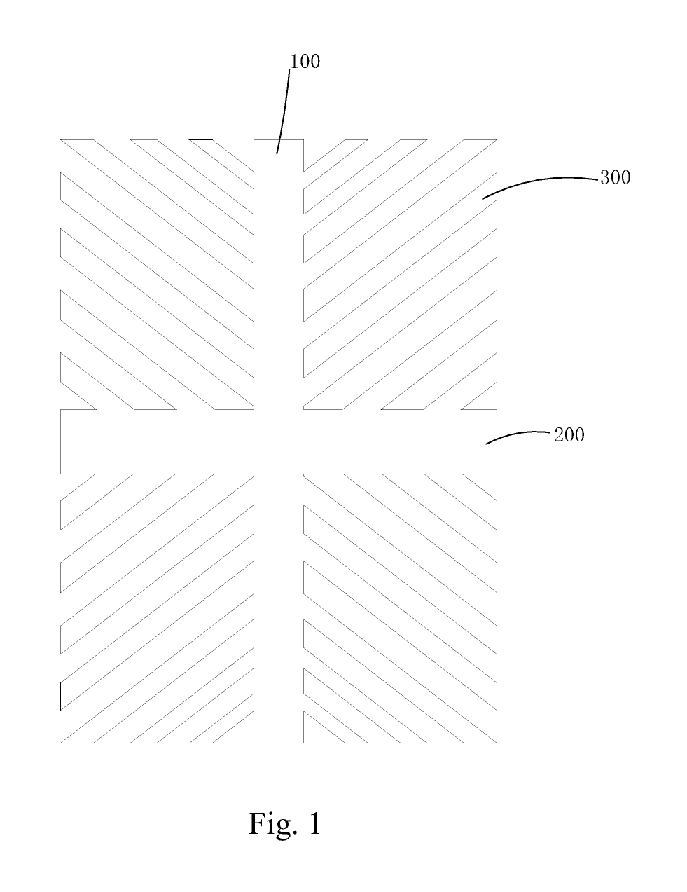

Specifically, both the main region pixel electrode 51 and the sub region pixel electrode 52 are pozidriv structures, which are the same as prior art. Please refer to FIG. 1. Both the main region pixel electrode 51 and the sub region pixel electrode 52 which are pozidriv structures comprise the strip vertical trunk 100 and strip horizontal trunk 200, and the centers of the vertical trunk 100 and the horizontal trunk 200 are perpendicularly intersecting. The center intersection means that the vertical trunk 100 and the horizontal trunk 200 are orthogonal, and the two equally split the area of the entire pixel electrode into 4 domains. Each pixel electrode region is composed with spread strip branches 300 appearing ±45°, ±135° angles with the vertical trunk 100 or the horizontal trunk 200. The respective strip branches 300 are positioned in the same plane where the vertical trunk 100 and the horizontal trunk 200 are to form the pozidriv pixel electrode structure which are mirror symmetric up and down, left and right shown in FIG. 1 so that the liquid crystals in the different regions lie down toward different directions.

Both the main region pixel electrode 51 and the sub region pixel electrode 52 are Indium Tin Oxide (ITO) thin films.

In conclusion, in the pixel driving circuit of the present invention, the nth main gate scan lines and the nth charge share gate scan lines are located corresponding to the pixel units of the nth row. The main gate scan line controls the charge of the main region pixel electrode and the sub region pixel electrode, and the charge share gate scan line controls the voltage level of the sub region pixel electrode to be pulled down. The first GOA driving module is located to provide the main gate scan pulse signal, and the second GOA driving module is located to provide the charge share gate scan pulse signal, and the first GOA driving module performs driving with advancing one pulse width before the second GOA driving module so that the nth main gate scan pulse signal transmitted by the nth main gate scan line advances one pulse width before the nth charge share gate scan pulse signal transmitted by the nth charge share gate scan line. Either in the forward scan driving or the backward scan driving, the function of color shift compensation can be realized to promote the display quality of the liquid crystal panel.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A pixel driving circuit, comprising: a plurality of pixel units aligned in array, nth main gate scan lines, being located from top to bottom corresponding to pixel units of nth rows and extending along a horizontal direction, nth charge share gate scan lines, being located from top to bottom corresponding to pixel units of the nth rows and extending along the horizontal direction and mth data lines, being located from left to right corresponding to the pixel units of mth columns and extending along a vertical direction, and both n and m are positive integers;
each pixel unit comprises a first thin film transistor, a second thin film transistor, a third thin film transistor, a main region pixel electrode, a sub region pixel electrode and a charge share capacitor; for the pixel unit of the nth row, the mth column, a gate of the first thin film transistor is electrically coupled to the nth main gate scan line, and a source is electrically coupled to the mth data line, and the drain is electrically coupled to the main region pixel electrode, and a gate of the second thin film transistor is electrically coupled to the nth main gate scan line, and a source is electrically coupled to the mth data line, and the drain is electrically coupled to the sub region pixel electrode, and a gate of the third thin film transistor is electrically coupled to the nth charge share gate scan line, and a source is electrically coupled to the sub region pixel electrode, and a drain is electrically coupled to one end of the charge share capacitor, and the other end of the charge share capacitor receives a common voltage;
the nth main gate scan line transmits a nth main gate scan pulse signal, the nth charge share gate scan line transmits a nth charge share gate scan pulse signal, and the nth main gate scan pulse signal advances one pulse width before the nth charge share gate scan pulse signal.

2. The pixel driving circuit according to claim 1, further comprising: a first GOA driving module and a second GOA driving module, and the first GOA driving module is electrically coupled to all the main gate scan lines to provide the main gate scan pulse signal to the main gate scan lines, and the second GOA driving module is electrically coupled to all the charge share gate scan lines to provide the charge share gate scan pulse signal to the charge share gate scan lines;
the first GOA driving module and the second GOA driving module perform forward scan driving at the same time or perform the backward scan driving at the same time; the first GOA driving module performs driving with advancing one pulse width before the second GOA driving module.

3. The pixel driving circuit according to claim 2, wherein a line by line scan of the main gate scan lines is started by inputting a first scan start signal to the first GOA driving module; a line by line scan of the charge share gate scan lines is started by inputting a second scan start signal to the second GOA driving module; the first scan start signal advances one pulse width before the second scan start signal.

4. The pixel driving circuit according to claim 2, wherein as the first GOA driving module and the second GOA driving module perform forward scan driving at the same time, the first GOA driving module provides the main gate scan pulse signal in a sequence from the first to the last, and the main gate scan lines transmit the main gate scan pulse signal line by line from top to bottom in a sequence from the first to the last, and the second GOA driving module provides the charge share gate scan pulse signal in a sequence from the first to the last, and the charge share gate scan lines transmit the charge share gate scan pulse signal line by line from top to bottom in a sequence from the first to the last.

5. The pixel driving circuit according to claim 2, wherein as the first GOA driving module and the second GOA driving module perform the backward scan driving at the same time, the first GOA driving module provides the main gate scan pulse signal in a sequence from the last to the first, and the main gate scan lines transmit the main gate scan pulse signal line by line from bottom to top in a sequence from the last to the first, and the second GOA driving module provides the charge share gate scan pulse signal in a sequence from the last to the first, and the charge share gate scan lines transmit the charge share gate scan pulse signal line by line from bottom to top in a sequence from the last to the first.

6. The pixel driving circuit according to claim 1, wherein both the main region pixel electrode and the sub region pixel electrode are pozidriv structures, and both materials are ITO.

7. The pixel driving circuit according to claim 1, wherein pulse widths of the main gate scan pulse signal and the charge share gate scan pulse signal are equal.

8. The pixel driving circuit according to claim 2, wherein the first GOA driving module and the second GOA driving circuit are respectively located at left, right two sides of the plurality of pixel units aligned in array.

9. A pixel driving circuit, comprising: a plurality of pixel units aligned in array, nth main gate scan lines, being located from top to bottom corresponding to pixel units of nth rows and extending along a horizontal direction, nth charge share gate scan lines, being located from top to bottom corresponding to pixel units of the nth rows and extending along the horizontal direction and mth data lines, being located from left to right corresponding to the pixel units of mth columns and extending along a vertical direction, and both n and m are positive integers;
each pixel unit comprises a first thin film transistor, a second thin film transistor, a third thin film transistor, a main region pixel electrode, a sub region pixel electrode and a charge share capacitor; for the pixel unit of the nth row, the mth column, a gate of the first thin film transistor is electrically coupled to the nth main gate scan line, and a source is electrically coupled to the mth data line, and the drain is electrically coupled to the main region pixel electrode, and a gate of the second thin film transistor is electrically coupled to the nth main gate scan line, and a source is electrically coupled to the mth data line, and the drain is electrically coupled to the sub region pixel electrode, and a gate of the third thin film transistor is electrically coupled to the nth charge share gate scan line, and a source is electrically coupled to the sub region pixel electrode, and a drain is electrically coupled to one end of the charge share capacitor, and the other end of the charge share capacitor receives a common voltage;
the nth main gate scan line transmits a nth main gate scan pulse signal, the nth charge share gate scan line transmits a nth charge share gate scan pulse signal, and the nth main gate scan pulse signal advances one pulse width before the nth charge share gate scan pulse signal;
the pixel driving circuit further comprises: a first GOA driving module and a second GOA driving module, and the first GOA driving module is electrically coupled to all the main gate scan lines to provide the main gate scan pulse signal to the main gate scan lines, and the second GOA driving module is electrically coupled to all the charge share gate scan lines to provide the charge share gate scan pulse signal to the charge share gate scan lines;
the first GOA driving module and the second GOA driving module perform forward scan driving at the same time or perform the backward scan driving at the same time; the first GOA driving module performs driving with advancing one pulse width before the second GOA driving module;
wherein both the main region pixel electrode and the sub region pixel electrode are pozidriv structures, and both materials are ITO.

10. The pixel driving circuit according to claim 9, wherein a line by line scan of the main gate scan lines is started by inputting a first scan start signal to the first GOA driving module; a line by line scan of the charge share gate scan lines is started by inputting a second scan start signal to the second GOA driving module; the first scan start signal advances one pulse width before the second scan start signal.

11. The pixel driving circuit according to claim 9, wherein as the first GOA driving module and the second GOA driving module perform forward scan driving at the same time, the first GOA driving module provides the main gate scan pulse signal in a sequence from the first to the last, and the main gate scan lines transmit the main gate scan pulse signal line by line from top to bottom in a sequence from the first to the last, and the second GOA driving module provides the charge share gate scan pulse signal in a sequence from the first to the last, and the charge share gate scan lines transmit the charge share gate scan pulse signal line by line from top to bottom in a sequence from the first to the last.

12. The pixel driving circuit according to claim 9, wherein as the first GOA driving module and the second GOA driving module perform the backward scan driving at the same time, the first GOA driving module provides the main gate scan pulse signal in a sequence from the last to the first, and the main gate scan lines transmit the main gate scan pulse signal line by line from bottom to top in a sequence from the last to the first, and the second GOA driving module provides the charge share gate scan pulse signal in a sequence from the last to the first, and the charge share gate scan lines transmit the charge share gate scan pulse signal line by line from bottom to top in a sequence from the last to the first.

13. The pixel driving circuit according to claim 9, wherein pulse widths of the main gate scan pulse signal and the charge share gate scan pulse signal are equal.

14. The pixel driving circuit according to claim 9, wherein the first GOA driving module and the second GOA driving circuit are respectively located at left, right two sides of the plurality of pixel units aligned in array.
